(19) United States
(12) Patent Application Publication
(10) Pub. No.: US 2008/0211460 A1
(43) Pub. Date: Sep. 4, 2008

(54) CHARGING METHOD AND SYSTEM FOR ADJUSTING CHARGING CURRENT

(75) Inventors: Chuang Chih Tarng, Taipei City (TW); Chen Chia Chang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei City (TW)

(21) Appl. No.: 11/766,803

(22) Filed: Jun. 22, 2007

(30) Foreign Application Priority Data
Mar. 2, 2007 (TW) 96107132

(51) Int. Cl. H02J 7/04

(52) U.S. Cl. 320/161

(57) ABSTRACT

A charging method and a system for adjusting a charging current are provided. A charge capacity and a charge current rate of a rechargeable battery are read for adjusting an output current of a battery charger. As a result, the output current of the battery charger can be adjusted according to the decrease of the charge capacity of the rechargeable battery, thereby achieving the purpose of elongating the service life of the rechargeable battery.

### CROSS-REFERENCE TO RELATED APPLICATION

This application claims the priority benefit of Taiwan application serial no. 96107132, filed Mar. 2, 2007. All disclosure of the Taiwan application is incorporated herein by reference.

### BACKGROUND OF THE INVENTION

1. Field of the Invention

The present invention relates to a charging method and system, and more particularly to a charging method and system for adjusting an output current of a charger in a charge/discharge cycle.

2. Description of Related Art

Generally speaking, with the increasement of use frequency and time, the capacity of a rechargeable battery itself is reduced and the energy storage capability is gradually deteriorated due to the aging phenomenon of the rechargeable battery. However, when the rechargeable battery is charged, a conventional charger may use a constant output current as a charging current to charge the rechargeable battery. That is to say, the output current output by the charger does not changed along with the reduction of the charge capacity of the rechargeable battery, and on the contrary, the output current is always output by a fixed value.

FIG. 1 is a table recording a charge capacity, a charging current rate, and variations of a charging current in different charge/discharge cycles under a conventional charging method. Referring to FIG. 1, with the charge/discharge cycle being increased, and due to the influence of the aging phenomenon, the charge capacity of the rechargeable battery is naturally reduced from 5000 mAH to 4000 mAH as shown in the second column in FIG. 1. Under the circumstance the charging current (i.e., the output current of the charger) provided by the charger is fixed by 3500 mA as shown in the fourth column in FIG. 1, it can be found that the charging current rate (charging current/charge capacity) shown in the third column in FIG. 1 rises from 0.7 to 0.875. With regard to such a charging method, the degradation of the rechargeable battery becomes serious due to the repeated charge/discharge courses, thereby shortening the service life of the rechargeable battery.

### SUMMARY OF THE INVENTION

In view of the above, the present invention provides a charging method for adjusting a charging current, in which an output current of a battery charger is adjusted for elongating the service life of a rechargeable battery accordingly.

The present invention provides a charging system for adjusting a charging current, which adjusts the output current of the battery charger according to a charge capacity of the rechargeable battery, thereby reducing the loss rate of the rechargeable battery.

The charging method for adjusting the charging current provided by the present invention includes, firstly, reading a charge capacity and a charging current rate of a rechargeable battery; and then, adjusting an output current of a battery charger according to the charging current rate and the charge capacity.

The charging method for adjusting the charging current according to an embodiment of the present invention, wherein the step of reading the charge capacity and the charging current rate of the rechargeable battery includes connecting the rechargeable battery through a system management bus (SMBus), reading the charge capacity, a design charging current, and a design capacity of the rechargeable battery through the system management bus, and then calculating the charging current rate according to the design charging current and the design capacity.

The charging method for adjusting the charging current according to an embodiment of the present invention, wherein the step of calculating the charging current rate according to the design charging current and the design capacity includes using the ratio of the design charging current to the design capacity as a charging current rate.

The charging method for adjusting the charging current according to an embodiment of the present invention, wherein the step of adjusting the output current of the battery charger according to the charging current rate and the charge capacity includes adjusting the output current to be a product of the charging current rate and the charge capacity.

The charging method for adjusting the charging current according to an embodiment of the present invention, wherein after the step of adjusting the output current of the battery charger according to the charging current rate and the charge capacity, the charging method further includes continuously outputting the output current to the rechargeable battery till the rechargeable battery is fully charged.

The charging method for adjusting the charging current according to an embodiment of the present invention, wherein the step of continuously outputting the output current to the rechargeable battery till the rechargeable battery is fully charged further includes reducing the output current if a charge voltage of the rechargeable battery arrives at a specific voltage, and determining that the rechargeable battery is fully charged when the output current is smaller than a specific current.

The charging method for adjusting the charging current according to an embodiment of the present invention wherein the rechargeable battery comprises a smart battery.

From another point of view, a charging system for adjusting a charging current provided by the present invention includes a battery charger, a reading interface, and a processing unit. The battery charger is used to output an output current. The reading interface is used to read the charge capacity and the charging current rate of the rechargeable battery. And the processing unit is coupled to the reading interface to adjust the output current of the battery charger according to the charging current rate and the charge capacity of the rechargeable battery.

The charging system for adjusting a charging current according to an embodiment of the present invention further comprises a storage unit for storing the charging current rate.

The charging system for adjusting a charging current according to an embodiment of the present invention wherein the rechargeable battery comprises a smart battery.

The charging system for adjusting a charging current according to an embodiment of the present invention wherein the reading interface comprises a system management bus.

In the present invention, the output current of the battery charger is adjusted by reading the present charge capacity and charging current rate of the rechargeable battery, therefore, the output current is adjusted along with the reduction of the charge capacity, thereby achieving the purpose of elongating the service life of the rechargeable battery.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a table recording a charge capacity, a charging current rate, and variations of a charging current in different charge/discharge cycles under a conventional charging method.

FIG. 2 is a block diagram of a charging system for adjusting a charging current according to an embodiment of the present invention.

FIG. 3 is a flow chart of a charging method for adjusting a charging current according to an embodiment of the present invention.

FIG. 4 is a table recording a charge capacity, a charging current rate, and variations of a charging current in different charge/discharge cycles under the charging method for adjusting a charging current provided by the present invention.

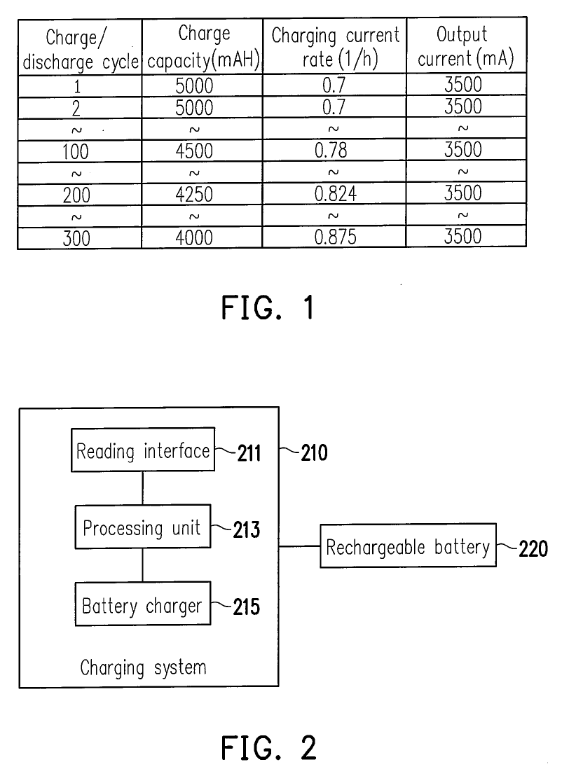

### DESCRIPTION OF EMBODIMENTS

In a charge/discharge cycle of a rechargeable battery, if a charger is capable of adjusting an output current along with the variations of a current charge capacity of the rechargeable battery, the charging current rate of the rechargeable battery is maintained unchanged, so as to reduce the loss rate of the rechargeable battery accordingly. In view of the above, the present invention provides a charging method and system for adjusting a charging current. In order to make the contents of the present invention more comprehensible, embodiments are described as the examples according which the present invention is implemented.

FIG. 2 is a schematic view of a charging system for adjusting a charging current according to an embodiment of the present invention. Referring to FIG. 2, the charging system 210 includes a reading interface 211, a processing unit 213, and a battery charger 215. The reading interface 211 is used to read a charge capacity and a charging current rate of a rechargeable battery 220. The battery charger 215 is used to output an output current to the rechargeable battery 220. The processing unit 213 is connected to the reading interface 211, and adjusts the output current of the battery charger 215 according to the charging current rate and the charge capacity of the rechargeable battery 220 read by the reading interface 211.

Furthermore, the charging system 210 further includes a storage unit (not shown) for storing the charging current rate of the rechargeable battery 220. In this embodiment, the rechargeable battery 220 is a smart battery which is fabricated based on a smart battery system (SBS) and has the function of recording and providing the state of the battery. The reading interface 211 includes a system management bus (SMBus).

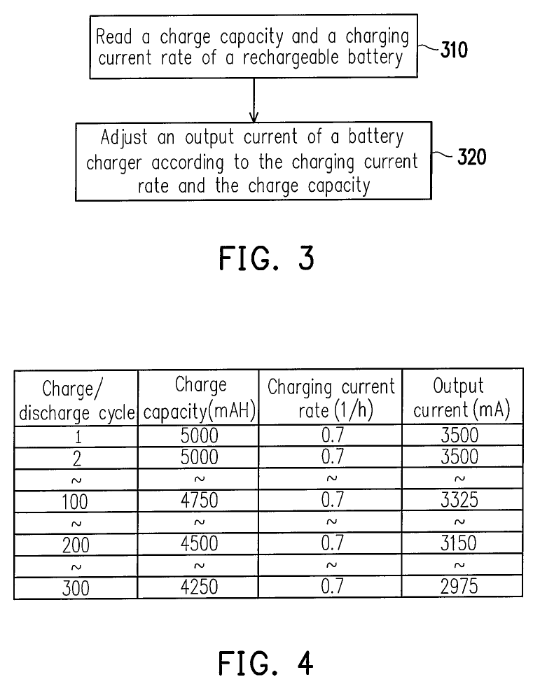

In order to illustrate the operation flow of the charging system for adjusting the charging current provided by the present invention in detail, another embodiment is provided to further illustrate the present invention. FIG. 3 is a flow chart of a charging method for adjusting a charging current according to an embodiment of the present invention. Referring to FIG. 3, as shown in Step 310, when the rechargeable battery 220 is to be charged, a current charge capacity and a charging current rate of the rechargeable battery 220 are firstly read by the reading interface 211 in the charging system 210. In this embodiment, the rechargeable battery 220 is, for example, a smart battery, and the smart battery has a plurality of fields for recording the charge capacity, a design charging current, a design capacity, and other status information. The charge capacity is naturally decreased with the increasement of the number of the charge/discharge cycles, and the design charging current and the design capacity correspond to the rechargeable battery 220 and are fixed values.

In this embodiment, the reading interface 211 is, for example, a system management bus. The charging system 210 is connected to the rechargeable battery 220 through the system management bus, and reads the design charge capacity, the design capacity, and the current charge capacity of the rechargeable battery 220 through the system management bus. Finally, the processing unit 213 calculates the charging current rate according to the design charging current and the design capacity. In an embodiment, the charging current rate is, for example, a ratio of the design charging current to the design capacity, and the charging current rate calculated by the processing unit 213 is, for example, stored in the storage unit (not shown) of the charging system 210. Therefore, when the charging system 210 charges the same rechargeable battery 220 next time, the charging current rate may be obtained directly from the storage unit, thereby reducing the possible time spent in reading information.

After the charging current rate and the charge capacity of the rechargeable battery 220 are obtained, in Step 320, the processing unit 213 adjusts a output current of the battery charger 215 according to the charging current rate and the charge capacity. In this embodiment, the processing unit 213, for example, adjusts the output current to be the product of the charging current rate and the charge capacity. The processing unit 213 further controls the battery charger 215 to continuously output the output current to the rechargeable battery 220, till the rechargeable battery 220 is fully charged.

In this embodiment, for example, with regard to a charging method with a constant current and a constant voltage (CC/CV), at the beginning of the charging process, the battery charger 215 continuously outputs the adjusted output current to the rechargeable battery 220 according to the calculation result of the processing unit 213. After a period of time, if a charge voltage of the rechargeable battery 220 has arrived at a specific voltage, the processing unit 213 controls the battery charger 215 to reduce the output current. However, when the output current is smaller than a specific current, the processing unit 213 determines that the rechargeable battery 220 is fully charged, thereby informing the battery charger 215 to stop providing any output current and voltage to the rechargeable battery 220, so as to finish the whole charging process.

FIG. 4 is a table recording a charge capacity, a charging current rate, and variations of a charging current in different charge/discharge cycles under the charging method for adjusting a charging current provided by the present invention. In this embodiment, it is assumed that a design charging current of a rechargeable battery is 3500 mA, and a design capacity of the rechargeable battery is 5000 mAH. In the 300ₜₕ charge/discharge cycle, the charge capacity of the rechargeable battery is reduced from 5000 mAH to 4250 mAH. Through the aforementioned method, a charging current rate is calculated to be 0.7 (3500 mAH/5000 mAH); therefore, when a battery charger charges the rechargeable battery, a output current should be 2975 mA (0.7*4250 mAH).

In view of the above, the charging method and system for adjusting a charging current provided by the present invention has at least the following advantages.

1. According to the current charge capacity of the rechargeable battery, the output current of the battery charger is adjusted, thereby maintaining a constant charging current rate.

2. The rechargeable battery is charged in a constant charging current rate, thereby reducing the degradation of the rechargeable battery.

3. Through the method for adjusting the charging current according to the charge capacity of the rechargeable battery, the service life of the rechargeable battery is elongated.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A charging method for adjusting a charging current, comprising:
reading a charge capacity and a charging current rate of a rechargeable battery; and
adjusting an output current of a battery charger according to the charging current rate and the charge capacity.

2. The charging method for adjusting a charging current as claimed in claim 1, wherein the step of reading the charge capacity and the charging current rate of the rechargeable battery comprises:
connecting with the rechargeable battery through a system management bus (SMBus);
reading the charge capacity, a design charging current, and a design capacity of the rechargeable battery through the system management bus; and
calculating the charging current rate according to the design charging current and the design capacity.

3. The charging method for adjusting a charging current as claimed in claim 2, wherein the step of calculating the charging current rate according to the design charging current and the design capacity comprises:
using a ratio of the design charging current to the design capacity as the charging current rate.

4. The charging method for adjusting a charging current as claimed in claim 1, wherein the step of adjusting the output current of the battery charger according to the charging current rate and the charge capacity comprises:
adjusting the output current to be a product of the charging current rate and the charge capacity.

5. The charging method for adjusting a charging current as claimed in claim 1, wherein after the step of adjusting the output current of the battery charger according to the charging current rate and the charge capacity, further comprising:
continuously outputting the output current to the rechargeable battery till the rechargeable battery is fully charged.

6. The charging method for adjusting a charging current as claimed in claim 5, wherein the step of continuously outputting the output current to the rechargeable battery till the rechargeable battery is fully charged further comprises:
reducing the output current if a charge voltage of the rechargeable battery reaches a specific voltage; and
determining that the rechargeable battery is fully charged when the output current is smaller than a specific current.

7. The charging method for adjusting a charging current as claimed in claim 1, wherein the rechargeable battery comprises a smart battery.

8. A charging system for adjusting a charging current, comprising:
a battery charger, for outputting an output current;
a reading interface, for reading a charge capacity and a charging current rate of a rechargeable battery; and
a processing unit, coupled to the reading interface for adjusting the output current of the battery charger according to the charging current rate and the charge capacity of the rechargeable battery.

9. The charging system for adjusting a charging current as claimed in claim 8, further comprising:
a storage unit, for storing the charging current rate.

10. The charging system for adjusting a charging current as claimed in claim 8, wherein the rechargeable battery comprises a smart battery.

11. The charging system for adjusting a charging current as claimed in claim 8, wherein the reading interface comprises a system management bus.
